(19) United States
(12) Patent Application Publication
(10) Pub. No.: US 2007/0135287 A1
(43) Pub. Date: Jun. 14, 2007

(54) Folding machine for folding continuous web material and relative folding method

(75) Inventors: Alessandro Morelli, Lucca (IT); Mauro Gelli, Lucca (IT)

Correspondence Address: BREINER & BREINER, L.L.C., P.O. BOX 19290, ALEXANDRIA, VA, 22320-0290, US

(73) Assignee: Fabio Perini S.P.A., Lucca (IT)

(21) Appl. No.: 10/588,010

(22) PCT Filed: Feb. 7, 2005
(86) PCT No.: PCT/IT05/00055

§ 371 Date: Aug. 1, 2006

(30) Foreign Application Priority Data
Feb. 11, 2004 (IT) FI2004A000030

(51) Int. Cl. B31F 1/00

(52) U.S. Cl. 493/432

(57) ABSTRACT

The folding machine comprises at least one folding cylinder (1, 3; 505) provided with at least one gripping member (43; 513) to mechanically grasp the web material (N) along a folding line. An electrostatic attraction member (79; 515) is associated with the gripping member (43; 513) to attract the web material towards said gripping member (43; 513).

### TECHNICAL FIELD

The present invention relates to a folding machine for folding a web material along transverse folding lines. More specifically, but not exclusively, the invention relates to a folding machine of the type comprising a pair of counter-rotating folding cylinders, adjacent and with parallel axes, each of which has at least one gripping member to grasp the web material along transverse lines and make folds along said lines.

The invention also relates to a method for performing zigzag folding of a continuous web material according to transverse lines.

### STATE OF THE ART

In many folding machines used in the paper converting field, for example, to produce folded paper napkins, a continuous web material—optionally folded in advance according to a longitudinal line—is fed to a pair of counter-rotating folding cylinders, disposed adjacent to each other to define a nip for the web material to pass through; and with parallel axes. Members which perform folding of the web material are disposed on each cylinder. The aforesaid members are disposed and controlled so that the web material is folded in a zigzag configuration, alternately adhering first to one and then to the other of the two counter-rotating folding cylinders. The pack formed by the web material folded with a zigzag configuration is then cut by a blade and divided into two rows of napkins or analogous folded products.

A machine of this type is described, for example, in WO-A-9728076 and in WO-A-0162651. Other examples of folding machines are described in U.S. Pat. No. 3,195,882, in U.S. Pat. No. 3,229,974, in U.S. Pat. No. 3,820,774, in U.S. Pat. No. 3,689,061, in German patent 4.446.753 and in German patent 429.288.

The folding members of these folding machines comprise on each folding cylinder a gripping member which at each rotation of the cylinder grasps the web material along a folding line. To insert the web material into the gripping member, respective folding blades or wedges are located on each of the two folding cylinders, in positions angularly staggered with respect to the gripping members. To make a fold, a folding blade of one of the two folding cylinders and a gripping member of the other folding cylinder are positioned angularly to correspond with each other in the nip defined between the two folding cylinders, so that the web material is pushed inside the gripping member by the folding blade.

Typically, each of the two folding cylinders has at least one folding blade and one gripping member, so that for each complete turn of the pair of folding cylinders at least two folds are made on the web material.

The presence of folding blades and of gripping members on the counter-rotating folding cylinders makes these machines particularly complicated from a mechanical viewpoint. Moreover, the mechanical action of the folding blade or wedge on the web material tends to damage it. The folding blades are subject to rapid wear with consequent maintenance costs. Moreover, they are often made of a plastic material and can be easily deformed or broken in the event of jamming of the folding machine.

### OBJECTS AND SUMMARY OF THE INVENTION

The object of the present invention is to produce a folding machine of the type mentioned above which is simpler, but at the same time efficient and reliable.

This and other objects and advantages, which shall be apparent to those skilled in the art from reading the text hereunder, are obtained in substance with a folding machine comprising in combination: at least one folding cylinder with at least one mechanical gripping member to grasp the web material; associated with said at least one gripping member, an electrostatic attraction member to electrostatically attract the web material into the gripping member before it closes.

Electrostatic attraction causes, as shall be described in detail hereunder, the formation of a loop of web material, which is inserted into the gripping member. The latter is subsequently closed to fold and hold the web material.

The electrostatic attraction member can include any element kept at a suitable electric potential inside, for example, a cavity inside which there is a plate, a clamp member or another gripping member to retain and fold the material. The electrostatic attraction member can also be part of the gripping member. For example, it may be the same gripping plate used to mechanically grasp the loop of electrostatically attracted web material. Otherwise, it can be composed of a block or insert which forms a stop, fixed with respect to the folding cylinder, against which a mechanical retaining and gripping plate or clamp of the web material acts. Alternatively, an electrostatic bar can be provided, completely separate from and in addition to the gripping member. Combined solutions would also be possible, in which more than one element inserted into the cavity housing the gripping member is maintained at a suitable electrostatic voltage.

The web material can be electrostatically charged upstream of the folding cylinder, for example, also by simple rubbing against bars of a suitable material, such as a plastic material.

The folding cylinders and the other mechanical members with which the web material comes into contact before being gripped can be made of suitable materials to prevent the electrostatic charge from being dispersed on the web material.

Further advantageous features and embodiments of the machine according to the invention are indicated in the appended dependent claims.

According to a different aspect, the invention relates to a method for folding a web material according to transverse folding lines, comprising the steps of:
providing at least one folding cylinder equipped with at least one mechanical gripping member;
rotating the folding cylinder feeding the web material thereto;
engaging the web material with, said at least one gripping member.

Characteristically, according to the invention, the web material is inserted into the respective gripping members by means of electrostatic attraction.

In practice, two adjacent folding cylinders can be provided, equipped with gripping members that grasp the web material alternately, to fold it with a zigzag configuration.

Use of electrostatic attraction to insert the web material into the mechanical member which performs gripping and folding makes it unnecessary to use folding blades or wedges which, in known machines, are inserted between the gripping members which close against said blades or wedges causing rapid wear and damages to the web material. This results in advantages in terms of reliability of the machine, reduction in wear and vibration and, therefore, also reduction in noise.

Further advantageous characteristics of the method according to the invention are indicated in the appended claims and shall be described with reference to the accompanying drawings.

### BRIEF DESCRIPTION OF THE DRAWINGS

The invention shall now be better understood by following the description and accompanying drawing, which shows a non-limiting example of embodiment of the invention. In particular, in the drawing:

FIG. 1 shows a front view of the machine with the respective pair of folding cylinders;

FIG. 2 shows a plan view according to II-II in FIG. 1;

FIGS. 3A and 3B shows a schematic section of the folding area according to an plane orthogonal to the axes of rotation of the folding cylinders in two subsequent working positions;

FIG. 4 shows a variant of embodiment.

### DETAILED DESCRIPTION OF THE PREFERRED EMBODIMENTS OF THE INVENTION

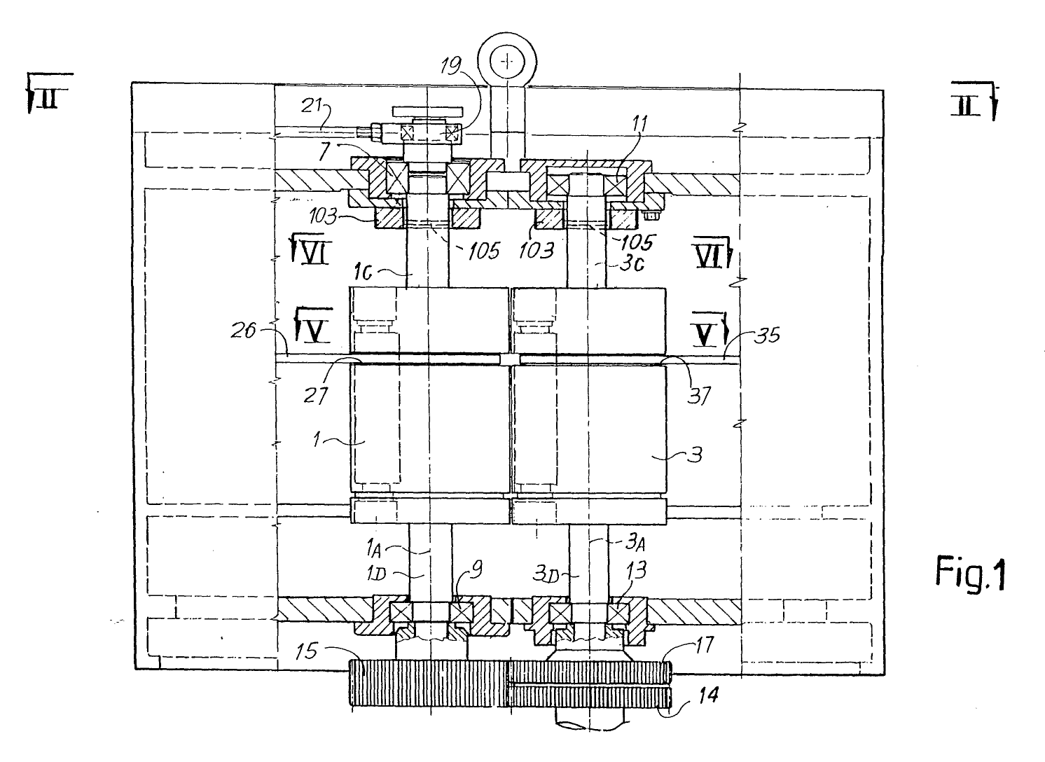

With initial reference to FIG. 1, the folding machine has a pair of folding cylinders 1 and 3 rotating about respective vertical axes of rotation 1A and 3A, disposed parallel to each other and distanced so that the two folding cylinders 1, 3 are adjacent to each other at the level of a nip 5. The folding cylinder 1 is supported by shanks 1C and 1D in corresponding supports 7, 9. The folding cylinder 3 is supported analogously by shanks 3C and 3D in supports 11 and 13.

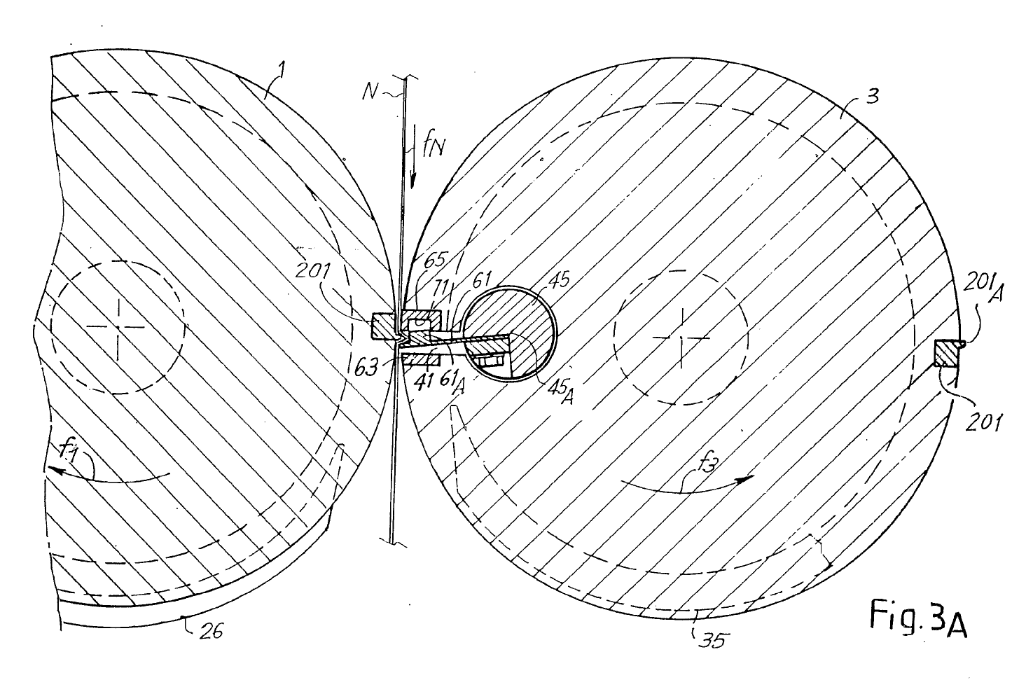

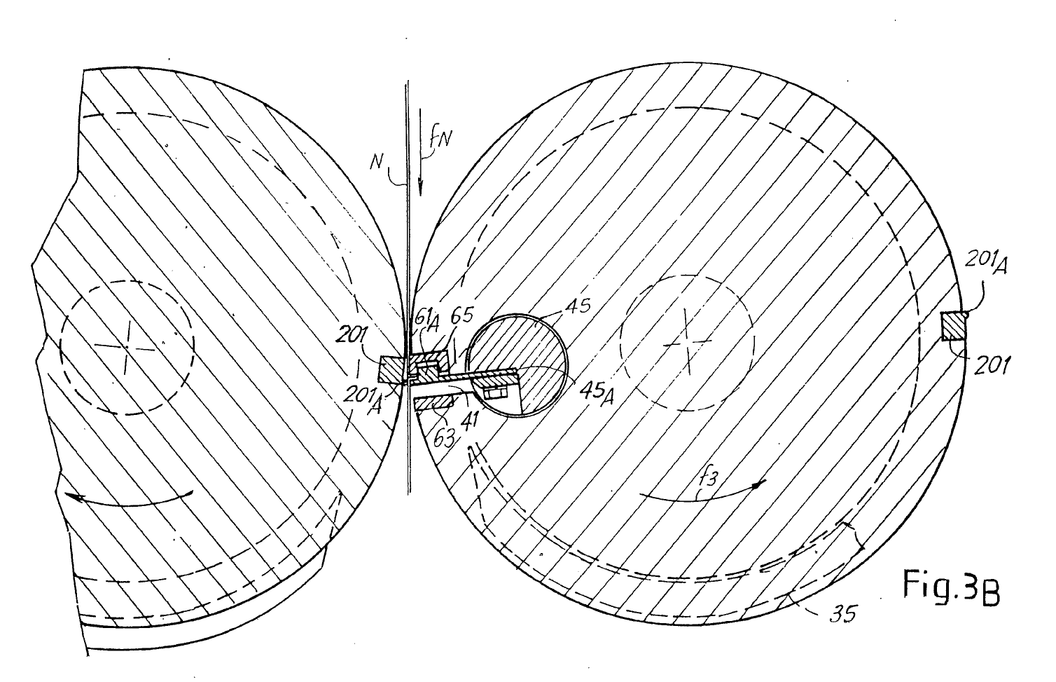

The two folding cylinders 1 and 3 are carried in rotation in opposite directions (arrows f1 and f3 in FIGS. 3A and 3B) by means of a toothed wheel 14 which meshes with a toothed wheel 15 keyed onto the shaft of the folding cylinder 1, and which in turn meshes with a toothed wheel 17 keyed onto the shaft of the folding cylinder 3.

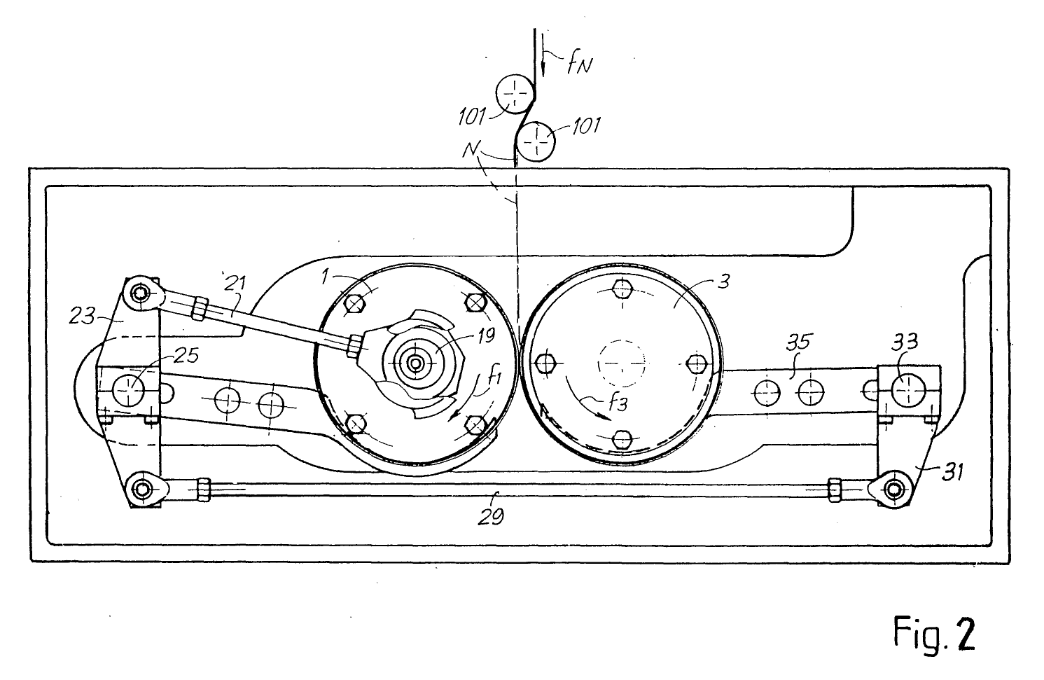

An eccentric 19 is mounted at the upper end of the shaft 1C of the folding cylinder 1, which, by means of a connecting rod 21, provides an alternate movement to a rocker 23 (see FIG. 2). The rocker 23 is keyed onto a vertical shaft 25, parallel to the axes of the two folding cylinders 1, 3 and carries integral therewith a shaped bar 26 which is inserted into an annular groove 27 of the folding cylinder 1.

Hinged to the rocker 23, at the opposite end to which the connecting rod 21 is hinged, is a further connecting rod 29, the opposite end of which, is hinged to a bracket 31 keyed onto a shaft 33, parallel to the shaft 25. Integral with the shaft 33 is a bar 35, analogous to the bar 26 integral with the shaft 25 and which is inserted into a groove 37 provided in the folding cylinder 3.

As can be seen in particular in the section in FIGS. 3A and 3B, longitudinal seats or cavities, indicated as a whole for both cylinders with 41, are produced inside the two folding cylinders 1, 3. The two cavities are symmetrical to each other and the folding cylinders are staggered from each other so that the cavities are in diametrically opposite positions.

The cavities 41 emerge on the cylindrical surface of each of the two folding cylinders 1, 3. Housed in each of the two seats or cavities of each folding cylinder 1, 3 is a gripping member, indicated as a whole with 43, used to grasp and fold the web material N fed into the nip 5 between the two folding cylinders 1, 3. The two gripping members 43 are symmetrical to each other and only one of them shall be described in detail hereunder.

The gripping member comprises, as can be seen in particular in FIGS. 3A, 3B, a shaft 45 with an axis 45A of oscillation parallel to the axis of rotation of the respective folding cylinder. The shaft 45 is provided with an oscillatory movement about its own axis, controlled by a groove cam, which is fixed with respect to the machine, and inside which a roller feeler is engaged, said feeler being carried by an arm integral with the shaft, according to a known arrangement (not shown).

Integral with the shaft 45 is a plate 61 fastened to the shaft 45 by screws 62. The plate 61 extends radially to reach approximately the cylindrical surface of the respective folding cylinder 1 or 3. When the shaft 45 oscillates about its axis, the plate 61 oscillates between two positions defined by two stops formed by a first block indicated as a whole with 63 and a second block indicated as a whole with 65. The two blocks 63, 65 are housed in the seat or cavity 41 of the respective folding cylinder. The blocks 63 and 65 extend longitudinally, parallel to the axis of the respective folding cylinder, for approximately the entire height thereof, and therefore involve the entire axial extension of the cavity 41. The block 65 has a longitudinal groove 71 into which a boss 61A can be inserted, formed on the plate 61 in proximity to the distal edge thereof, for the purposes described hereunder.

Disposed upstream of the nip 5 between the folding cylinders 1, 3 along the path of the web material N are a pair of plastic bars 101 against which the web material N rubs during advance towards the nip 5. In this way the material N, typically paper, is electrostatically charged. Alternatively, other systems can be used to electrostatically charge the web material, for example an electrode with tips facing towards the web material N to disperse the charges towards the material.

The two blocks 63 and 65 housed in each cavity 41 are made of electrically conductive material and are in contact with a voltage source at a potential of the opposite sign with respect to the potential with which the web material N is electrostatically charged when passing over the bars 101. The electrical connection between the two blocks 63 and 65 and the voltage source is obtained, for example, by means of a collector 103 with a contact brush and a conductive track 105, indicated schematically in FIG. 1, for each of the two cylinders 1, 3.

The folding machine described above operates in the following way.

The two folding cylinders 1 and 3 rotate in opposite directions as represented by the arrows f1 and f3, while the web material N (optionally already folded according to a continuous longitudinal folding line), is fed into the nip 5 between the two folding cylinders. The material N is electrostatically charged before reaching the nip 5.

As can be seen in particular in FIGS. 3A and 3B the gripping members housed in the two cavities 41 of the two folding cylinders 1 and 3 are disposed in angularly staggered positions so that when the gripping member of the folding cylinder 3 is at the level of the nip 5, the gripping member associated with the folding cylinder 1 is in the diametrically opposite position with respect to the nip between the cylinders.

The two angular positions shown in FIGS. 3A and 3B are those in which the web material is inserted into the gripping member of the folding cylinder 3 and the gripping member is subsequently closed. An analogous operation is performed after rotation through 180° for the gripping member associated with the folding cylinder 1.

The web material N is inserted into the cavity 41, between the block 65 and the plate 61, through the effect of electrostatic attraction caused by the charges of opposite signs on the material N and on the block 65 and, optionally, on the block 63. The plate 61 could also be maintained at the same electrostatic potential as the block 65, if appropriate. Alternatively, or in combination, an electrostatic bar, with which the web material does not come into contact, could be provided inside the cavity.

Electrostatic attraction causes the formation of a loop of web material N (FIG. 3A), which is inserted into the gripping member 43 when this is in the open position, that is, with the plate 61 at a distance from the stop formed by the block 65. Subsequent oscillation of the plate 61 (FIG. 3B) causes closing and gripping of the web material with consequent forming of the fold and retention of the web material through the mechanical action of the plate 61.

The stop 61A provided on the plate 61 limits the quantity of web material N which, forming the loop, penetrates the gripping member.

Continuing counter-clockwise rotation of the folding cylinder 3, beyond the nip 5 between the folding cylinders 1 and 3, the web material continues to be held on the surface of the folding cylinder 3 through the effect of mechanical retention. The oscillating bar 35 associated with the folding cylinder 3 is in the withdrawn position inside the groove 37 of the cylinder. Consequently, the folded web material N is carried over the curved portion of said bar. When the plate 61 reaches a sufficiently advanced angular position, it is opened through the effect of counter-clockwise oscillation of the shaft 45 and the portion of folded web material is detached from the folding cylinder 3 by controlled oscillation of the bar 35. This operation to detach the folded web material from the folding cylinder is already known and similar to the procedure in known machines.

When the folded web material is released from the folding cylinder 3, the gripping member carried by the folding cylinder 1 is approaching the nip 5 between the folding cylinders. An analogous folding phase performed by the folding cylinder 1 then starts.

Thanks to the use of electrostatic charges to insert the web material into the gripping member, with respect to conventional machines (such as the type described in WO-A-0162651), the machine forming the object of the present invention is considerably simplified, as it is unnecessary to provide mechanical control systems for oscillation of the blade to insert the web material into the gripping member. Moreover, the absence of the folding blades also allows greater care in handling the material to be folded, which is therefore less liable to be damaged during folding.

To facilitate the start of formation of the fold and insertion by electrostatic attraction of the web material N into the gripping member, in this embodiment an element which facilitates initial electrostatic attraction of the material to be folded is provided between the plate 61 and the block 63 on each folding cylinder 1, 3 (in the position diametrically opposite the seat in which the folding plate 61 is housed). This element is composed of an insert 201 blocked in a slot of the respective cylinder 1 or 3, extending parallel to the axis of rotation of said cylinder. In practice, the insert 201 is divided into two portions, separated by the groove 27 or 37 of the respective cylinder.

The insert 201 has rib or boss 201A which projects slightly (by a few tens of millimeter, typically 0.1-0.5 mm) from the cylindrical side surface of the respective folding cylinder 1, 3. The two cylinders 1, 3 are staggered so that the boss 201A is carried in front of the gripping member 43 of the opposite cylinder, and more precisely to the space between the open plate 61 and the block 65. From the sequence represented in FIGS. 3A, 3B the function of the insert is understood. The web material N rests on the boss 201A and therefore projects from the surface of the cylinder towards the opening defined between the blade 61 and the block 65. This facilitates electrostatic attraction and formation of the loop. FIG. 3B shows the subsequent position, in which the boss 201A (through the effect of rotation of the folding cylinder 1) moves away from the plate 61. The latter closes to grip the web material N after the boss 201A has left the area in which it can interfere with movement of the plate. This prevents any mechanical contact between plate and insert 201 and therefore avoids the onset of wear, vibration and damage to the web material N resulting from rubbing between mechanical members carried by the two counter-rotating cylinders.

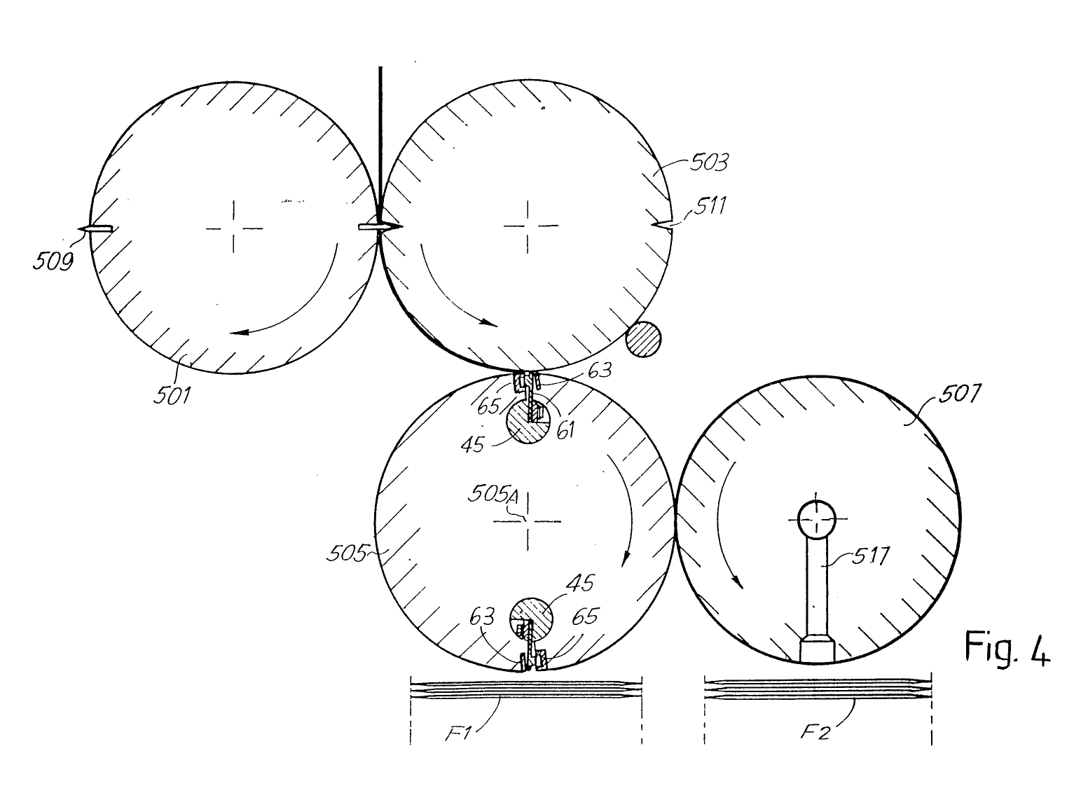

In the text hereinbefore the invention has been described applied to a specific folding machine, provided with two folding cylinders, on which the invention allows particular advantages to be obtained. Nonetheless, it can also be applied to folding machines with a different arrangement. By way of example, FIG. 4 shows a folding machine in which the web material is cut into sheets prior to transverse folding. Schematically, the machine has a cutting unit composed of two counter-rotating cylinders with parallel axes 501, 503. A nip is defined therebetween, through, which the web material N passes, optionally folded longitudinally before the transverse cut and fold. A pair of blades and counter-blades are indicated with 509 and 511, carried by the two cylinders 501, 503. The web material cut into individual sheets is held on the surface of the cylinder 503 by means of suction holes, not shown, and the individual sheets are thus made to enter a nip defined by the cylinder 503 and by a folding cylinder 505. In the example shown, this has a pair of mechanical gripping members 513 which can be produced analogously to the mechanical gripping members of the previous embodiment. Associated therewith are electrostatic attraction systems of the same type described with reference to FIGS. 3A and 3B.

The folding cylinder 505, which rotates about its own axis 505A, forms a nip with a distributor cylinder 507 having suction holes and which is used to divide the flow of folded sheets so that they are distributed (in a known way) into two rows F1, F2 upon delivery from the nip between the cylinders 505 and 507.

It is clear from this schematic example that the electrostatic system according to the invention used to insert a loop of web material into the gripping member to make the fold facilitates production of a machine in which the fold is made on the web material already divided into portions or sheets.

It is understood that the drawing purely shows a possible embodiment of the invention, which may vary in forms and arrangements without however departing from the scope of the concept on which the invention is based. Any reference numerals in the appended claims are provided for the sole purpose of facilitating reading in the light of the description hereinbefore and the attached drawings and do not in any manner limit the scope of protection.

1-20. (canceled)

21. Folding machine for folding a web material along transverse folding lines comprising at least one folding cylinder equipped with at least one gripping member to grasp the web material along a folding line, wherein an electrostatic system is associated with said at least one gripping member to attract the web material towards said gripping member.

22. Machine as claimed in claim 21, further comprising a system to electrostatically charge the web material before the web material reaches said gripping member.

23. Machine as claimed in claim 21, wherein two folding cylinders having parallel axes are present in counter-rotating relation to each other, each of said two folding cylinders being equipped with a gripping member of said at least one gripping member with said electrostatic system.

24. Machine according to claim 22, wherein two folding cylinders having parallel axes are present in counter-rotating relation to each other, each of said two folding cylinders being equipped with a gripping member of said at least one gripping member with said electrostatic system.

25. Folding machine as claimed in claim 21, wherein said at least one gripping member comprises a movable element cooperating with a first stop, the web material being electrostatically attracted between said movable element and said first stop.

26. Folding machine as claimed in claim 25, wherein said first stop is held at an electrostatic potential of an opposite sign with respect to an electrostatic potential of said web material.

27. Folding machine as claimed in claim 26, wherein said movable element cooperates with a second stop, said first stop and said second stop defining a slot essentially parallel to an axis of rotation of a respective one of said at least one folding cylinder, the movable element extending into said slot.

28. Folding machine as claimed in one of claims 21 to 24, wherein each of said at least one folding cylinder includes at least one cavity essentially parallel to an axis of rotation of said cylinder and opens onto a cylindrical surface of the folding cylinder, inside which a respective one of said at least one gripping member is housed, and wherein at least one retaining member, kept at an electrostatic potential to cause attraction of the web material, is housed in said cavity.

29. Folding machine as claimed in claim 28, wherein a first block defining said first stop is fixed in said cavity.

30. Folding machine as claimed in claim 28, wherein a second block defining said second stop is fixed in said cavity.

31. Folding machine as claimed in one of claims 21 to 24, wherein each of said at least one gripping member includes an elastic plate.

32. Folding machine as claimed in one of claims 21 to 24, further comprising a cutting unit associated with said at least one folding cylinder to cut the web material into individual sheets, which are folded by said at least one folding cylinder.

33. Folding machine as claimed in claim 32, wherein said cutting unit comprises two cylinders with axes parallel to each other and to a respective one of the at least one folding cylinder, said two cylinders being counter-rotating and defining therebetween a nip through which the web material passes, and said two cylinders being equipped with blades and counter-blades to cut the web material, and wherein one of said two cylinders forming the cutting unit form together with the at least one folding cylinder a nip through which the cut web material passes.

34. Folding machine as claimed in one of claims 21 to 24, wherein said at least one folding cylinder cooperates with a counter-cylinder, on which a boss is provided, extending parallel to the axis of said at least one cylinder, the boss being phased with respect to the at least one gripping member to facilitate folding of said web material.

35. Folding machine as claimed in claim 32, wherein provided on each of said at least one folding cylinder is a corresponding boss, each said corresponding boss of one of said at least one folding cylinder cooperating with a respective one of said at least one gripping member of an opposite folding cylinder.

36. Folding machine as claimed in claim 34, wherein provided on each of said at least one folding cylinder is a corresponding boss, each said corresponding boss of one of said at least one folding cylinder cooperating with a respective one of said at least one gripping member of an opposite folding cylinder.

37. A method for folding a web material according to transverse folding lines, comprising:
arranging at least one folding cylinder;
providing on said folding cylinder at least one gripping member;
rotating said folding cylinder about an axis thereof;
feeding the web material to said folding cylinder;
engaging the web material with said at least one gripping member of said folding cylinder;
wherein the web material is inserted into said gripping member by electrostatic attraction.

38. Method as claimed in claim 37, further comprising: arranging two of said at least one folding cylinder with parallel axes in counter-rotating relationship and defining a nip through which the web material is made to pass, each of said at least one folding cylinder being equipped with said at least one gripping member; and engaging the web material alternately with a respective one of said at least one gripping member of a first one of said at least one folding cylinder and with a respective one of said at least one gripping member of a second one of said at least one folding cylinder, to fold said web material with a zigzag configuration.

39. Method as claimed in claim 37 or 38, wherein the web material is gripped between a stop fixed with respect to a respective one of said at least one folding cylinder and a movable element.

40. Method as claimed in claim 37 or 38, wherein folding is facilitated in said web material in front of said at least one gripping member.

41. Method as claimed in claim 40, wherein folding is facilitated by a boss provided on a cylinder positioned opposite said at least one folding cylinder.

42. Method as claimed in claim 41, wherein said at least one gripping member does not cooperate mechanically with said boss.
